(19) United States
(12) Patent Application Publication
(10) Pub. No.: US 2005/0153094 A1
(43) Pub. Date: Jul. 14, 2005

(54) Optical storage medium

(75) Inventors: Hiroshi Tabata, Mito-Shi (JP); Naoyuki Kubo, Mito-Shi (JP); Wataru Kambara, Mito-Shi (JP); Takayuki Deno, Mito-Shi (JP); Iku Matsumoto, Mito-Shi (JP)

Correspondence Address: RENNER, KENNER, GREIVE, BOABAK, TAYLOR & WEBER, Fourth Floor, First National Tower, Akron, OH, 44308-1456, US

(73) Assignee: Vicrtor Company of Japan, Ltd.

(21) Appl. No.: 11/005,839

(22) Filed: Dec. 7, 2004

(30) Foreign Application Priority Data
Dec. 16, 2003 (JP) 2003-417671

(51) Int. Cl. G11B 7/26

(52) U.S. Cl. 428/64.4; 428/64.6; 428/65.2; 369/283

(57) ABSTRACT

An optical disk has a recording substrate and a support base. The substrate has a first light incident plane and a first bonding surface on both sides thereof, data being to be recorded in the substrate via the first plane. The base is constituted by at least one component and has a second light incident plane and a second bonding surface on both sides thereof, the substrate and the base being bonded to each other via the bonding surfaces. The substrate is constituted by components that are at least a first substrate, a recording layer and a reflective layer, the first substrate having a first substrate surface and a second substrate surface on both sides thereof, the first plane being provided on the first substrate surface, the recording layer being provided on the second substrate surface, the reflective layer made of at least silver and having a first layer surface and a second layer surface on both sides thereof, the first layer surface being provided on the recording layer as the first layer surface faces with the second substrate surface via the recording layer. At least one component that exists between the second plane of the support base and the second layer surface of the reflective layer exhibits a transmittancy in the range from 0% to 25% when the optical disk is exposed to light having a wavelength of 350 nm through the second light incident plane.

### CROSS-REFERENCE TO RELATED APPLICATIONS

This application is based on and claims the benefit of priority from the prior Japanese Patent Application No. 2003-417671 filed on Dec. 16, 2003, the entire contents of which are incorporated herein by reference.

### BACKGROUND OF THE INVENTION

The present invention relates to an optical storage medium in or from which data is recorded, erased or reproduced with laser radiation. Particularly, this invention relates to an optical storage medium that maintains excellent recording characteristics even though it is preserved under severe conditions such as high temperature, high humidity and light exposure (a fluorescent light, sunlight, etc.).

Optical storage media recently available are CD-R, CD-RW, and highly-dense media such as DVD-RW, DVD-RAM, DVD-R and blue-ray disk. CD and DVD are the abbreviations for a compact disc and a digital versatile disk, respectively.

In these storage media, a recording layer is subjected to light exposure to be heated so that recorded marks are formed thereon. Each recorded mark is treated like a pit on a storage medium only for reproduction use, and change in its reflectivity is detected as recorded data in reproduction. Optical storage media are highly compatible with storage media only for reproduction use.

Optical storage media have at least a recording layer and a reflective layer on a substrate.

Materials for the recording layer are an organic dye, such as azoic, cyanine or phthalocyanine dye, a phase-change inorganic material with SbTe as a major ingredient, a dual layer of inorganic materials, etc.

Materials for the reflective layer are those with metal exhibiting high reflectivity, such as, Ag, Al or Au, as a major ingredient. Popular materials for the reflective layer are, however, those with Ag or an alloy of Ag for high reflectivity in a wide range of wavelength. Nevertheless, Ag and an alloy of Ag are disadvantageous in storage stability when they are preserved under severe conditions such as high temperature, high humidity and light exposure. Because they strongly react with S, O₂, etc., and to light, and further easily form granular crystals.

Japanese Patent Publication No. 3-75939 (Patent No. 1709731) discloses protection of a reflective layer of an optical disk against corrosion at high temperature and humidity with an organic protective layer formed on the reflective layer to shield the reflective layer from surrounding environment such as air.

This optical disk was evaluated by the inventors of the present invention as follows: It exhibited high storage stability against preservation at high temperature and humidity whereas relatively low against light exposure, i. e. low recording characteristics against light, such as a fluorescent light or sunlight radiated onto the reflective-layer surface opposed to the recording surface, when the reflective layer was made of Ag or an alloy of Ag.

Moreover, Japanese Unexamined Patent Publication No. 7-201075 discloses an optical storage medium having an anti-corrosion layer between a reflective layer of Ag or an alloy of Ag and an organic protective layer, for high storage stability against preservation at high temperature and humidity.

In detail, an anti-corrosion layer, that exhibits high anti corrosion, is formed on a reflective layer of Ag or an alloy of Ag, to restrict corrosion of the reflective layer.

This optical storage medium was also evaluated by the inventors of the present invention as follows: The anti-corrosion layer of Al, Cu or an alloy of either metal was peeled off from the reflectively layer of Ag or an alloy of Ag, which then caused inferior recording characteristics due to light exposure. Thus, the optical storage medium could not maintain high storage stability when preserved at high temperature and humidity, and subjected to light exposure.

As discussed above, Ag or an alloy of Ag is a preferable material for the reflectively layer. It is, however, disadvantageous in that an optical storage medium having a reflective layer made of such material and an organic protective layer laminated to each other suffers inferior storage stability when the reflective layer is exposed to light.

The additional anti-corrosion layer also cannot offer high storage stability when an optical storage medium is preserved at high temperature and humidity and exposed to light, which although depends on the material of the anti-corrosion layer.

### SUMMARY OF THE INVENTION

A purpose of the present invention is to provide an optical storage medium that maintains excellent recording characteristics even though it is preserved under severe conditions such as high temperature, high humidity and light exposure.

The present invention provides an optical disk comprising: a recording substrate having a first light incident plane and a first bonding surface on both sides thereof, data being to be recorded in the recording substrate via the first light incident plane; and a support base constituted by at least one component and having a second light incident plane and a second bonding surface on both sides thereof, the recording substrate and the support base being bonded to each other via the first and second bonding surfaces, wherein the recording substrate is constituted by components that are at least a first substrate, a recording layer and a reflective layer, the first substrate having a first substrate surface and a second substrate surface on both sides thereof, the first incident plane being provided on the first substrate surface, the recording layer being provided on the second substrate surface, the reflective layer made of at least silver and having a first layer surface and a second layer surface on both sides thereof, the first layer surface being provided on the recording layer as the first layer surface faces with the second substrate surface via the recording layer, and at least one component that exists between the second light incident plane of the support base and the second layer surface of the reflective layer exhibits a transmittancy in the range from 0% to 25% when the optical disk is exposed to light having a wavelength of 350 nm through the second light incident plane.

Moreover, the present invention provides an optical disk comprising: a recording substrate having a first light incident plane and a first bonding surface on both sides thereof, data being to be recorded in the recording substrate via the first light incident plane; and a support base having a second bonding surface, the recording substrate and the support base being bonded to each other via the first and second bonding surfaces, wherein the recording substrate is constituted by at least a substrate, a recording layer, a reflective layer made of at least silver, an inert layer, and an organic protective layer, the substrate having a first substrate surface and a second substrate surface on both sides thereof, the first incident plane being provided on the first substrate surface, the recording layer, the reflective layer, the inert layer and the organic protective layer being provided on the second substrate surface in order, the inert layer restricting a chemical reaction between the reflective layer and the organic protective layer.

### BRIEF DESCRIPTION OF DRAWINGS

FIG. 1 illustrates an essential structure of an optical storage medium according to the present invention;

FIG. 2 illustrates a recording substrate used for a first embodiment of the optical storage medium according to the present invention;

FIGS. 3A to 3D illustrate several modifications to the dummy substrate shown in FIG. 1, applicable to the first embodiment of the optical storage medium according to the present invention;

FIG. 4 shows a graph indicating error rate in recording/reproduction on/from the optical storage medium after irradiated with incandescent or white light at 30,000 lux for 600 hours to transmittancy T of the dummy substrate to light of 350 nm in wavelength λ;

FIG. 5 shows a graph indicating transmittancy T at 350 nm in wavelength λ to thickness of the light shielding layer made of an alloy of Al;

FIG. 6 illustrates a recording substrate used for a second embodiment of the optical storage medium according to the present invention;

FIG. 7 shows a graph indicating error rate in recording/reproduction to adhesion strength between the reflective layer and the highly-adhesive inert layer; and

FIG. 8 illustrates a tensile test to measure adhesion strength between the reflective layer and the highly-adhesive inert layer.

### DETAILED DESCRIPTION OF PREFERRED EMBODIMENTS

Embodiments of the optical storage medium according to the present invention will be disclosed with reference to the attached drawings.

The same reference signs or numerals are given to the same or analogous elements throughout drawings.

Optical storage media which will be disclosed below are phase-change optical disks such as DVD-RW. The present invention is, however, also applicable to any other types of optical disks, optical cards, etc., having similar configuration, on which data can be repeatedly overwritten.

[Essential Structure of Optical Storage Medium]

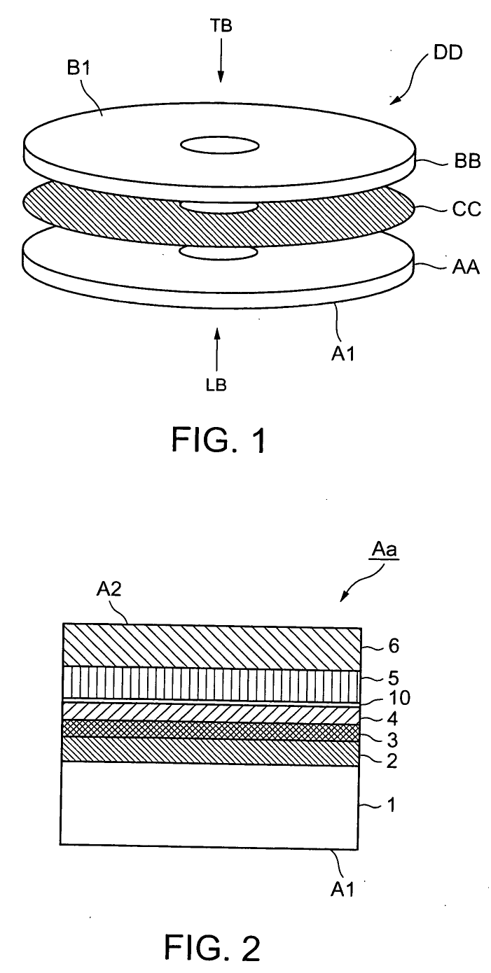

FIG. 1 illustrates an essential structure of an optical storage medium DD according to the present invention.

The optical storage medium DD has a recording substrate AA on which data is to be recorded and a dummy substrate BB, bonded to each other via an adhesive layer CC. The dummy substrate BB and the adhesive layer CC constitute a support base.

A laser beam LB for recording or reproduction is incident on an incident plane A1 (a first incident plane) of the recording substrate AA. A test light beam TB is incident on an incident plane B1 (a second incident plane) of the dummy substrate BB in evaluation of storage stability.

### First Embodiment of Optical Storage Medium

FIG. 2 shows a recording substrate Aa used for a first embodiment of the optical storage medium DD according to the present invention.

The recording substrate Aa has a first protective layer 2, a recording layer 3, a second protective layer 4, a barrier layer 10, a reflective layer 5, and a third protective layer 6, laminated in order on a substrate 1.

Although shown in FIG. 2, the barrier layer 10 and the third protective layer 6 are not essential components of this embodiment. In other words, they can be omitted or provided according to need, as discussed later.

A suitable material for the substrate 1 is a transparent material, such as, a transparent synthetic resin or a transparent glass, exhibiting transmittance of roughly from 85% to 100%.

The transparent substrate 1 is used for protection against dust, damage, etc. A focused laser beam reaches the recording layer 3 through the transparent substrate 1 in data recording.

A suitable material for the substrate 1 in such use is, for example, glass, polycarbonate, polymethylmethacrylate, polyolefin resin, epoxy resin, or polyimide resin. Most suitable material is polycarbonate resin for low birefringence and hygroscopicity, and also easiness to process.

In compatibility with DVD, the thickness of the substrate 1 is preferably in the range from 0.01 mm to 0.6 mm, particularly, 0.6 mm (for the total DVD thickness of 1.2 mm). This is because dust easily affect recording with a focused laser beam through the incident plane A1 when the thickness of the substrate 1 is less than 0.01 mm.

A practical thickness for the substrate 1 is in the range from 0.01 mm to 5 mm if there is no particular requirement for the total thickness of the optical storage medium DD. The thickness of the substrate 1 over 5 mm causes difficulty in increase in objective-lens numerical aperture, which leads to larger laser spot size, hence resulting in difficulty in increase in storage density.

The substrate 1 may be flexible or rigid. A flexible substrate 1 is used for tape-, sheet- or card-type optical storage media whereas a rigid substrate 1 for card- or disk-type optical storage media.

The first and second protective layers 2 and 4 protect the substrate 1 and the recording layer 3 against heat which may otherwise cause inferior recording characteristics and also against optical interference which may otherwise cause low signal contrast in reproduction.

The material for each of the first and second protective layers 2 and 4 allows a laser beam to pass therethrough in recording or reproduction and exhibits a refractive index “n”, preferably, in the range from 1.9 to 2.3.

A suitable material for each of these protective layers is a material that exhibits high thermal characteristics, for example, an oxide such as SiO₂, SiO, ZnO, TiO₂, Ta₂O₅, Nb₂O₅, ZrO₂ or MgO, a sulfide such as ZnS, In₂S₃ or TaS₄, or carbide such as SiC, TaC, WC or TiC, or a mixture of these materials. Among them, a mixture of ZnS and SiO₂ is the best for high recording sensitivity, C/N and erasing rate against repeated recording, reproduction or erasure.

The first and second protective layers 2 and 4 may or may not be made of the same material or composition.

The thickness of the first protective layer 2 is in the range from about 5 nm to 500 nm, preferably, 40 nm to 300 nm so that it cannot be easily peeled off from the substrate 1 or the recording layer 3 and is not prone to damage such as cracks. The thickness below 40 nm hardly offers high disk optical characteristics whereas over 300 nm causes lower productivity. More acceptable range for the thickness of the first protective layer 2 is in the range from 50 nm to 80 nm.

The thickness of the second protective layer 4 is, preferably, in the range from 5 nm to 40 nm for high recording characteristics such as C/N and erasing rate, and also high stability in a number of repeated overwriting. The thickness below 5 nm hardly gives enough heat to the recording layer 3, resulting in increase in optimum recording power, whereas over 40 nm causes inferior overwrite characteristics. More acceptable range for the thickness of the second protective layer 4 is in the range from 10 nm to 20 nm.

The recording layer 3 is a layer of an alloy such as Ag—In—Sb—Te or Ge—In—Sb—Te, or of Ge—In—Sb—Te added with Ag, Si, Al, Ti, Bi or Ga. A preferable thickness range for the recording layer 3 is from 10 nm to 25 nm. The thickness below 10 nm lowers crystallization rate which causes inferior recording at high speed whereas over 25 nm requires larger laser power.

The reflective layer 5 is made of a material that exhibits high thermal conductivity and also high reflectivity over a wide range of wavelength. Among others, Ag or an alloy of Ag is used. An alloy of Ag is a mixture of Ag and at least one of metals, such as, Cr, Au, Cu, Pd, Pt, Ni, Nd, In, Ca and Bi.

The thickness of the reflective layer 5 is, preferably, in the range from 50 nm to 300 nm, which depends on the thermal conductivity of a metal or an alloy used for this layer. The reflective layer 5 of 50 nm or more in thickness is optically stable in, particularly, reflectivity. Nevertheless, a thicker reflective layer 5 affects a cooling rate. The reflective layer 5 having the thickness over 300 nm requires a longer production time. A material exhibiting a high thermal conductivity allows the reflective layer 5 to have a thickness in an optimum range such as mentioned above.

The barrier layer 10 made of a material without sulfur is, preferably, provided between the second protective layer 4 and the reflective layer 5 when the layer 4 is made of a mixture including a sulfur compound, to restrict generation of a compound of AgS between the layers 4 and 5.

The third protective layer 6 is preferably provided for higher unproneness to physical damage or corrosion. It is preferably made of an organic substance. Especially, it is preferably made of a radiation-cured compound or a composition thereof cured with radiation of an electron beam, ultraviolet rays, etc. The thickness of the third protective layer 6 is usually in the range from 0.1 μm to 100 μm. The third protective layer 6 may be formed by a known technique, such as, spin coating, gravure coating, spray coating or dipping.

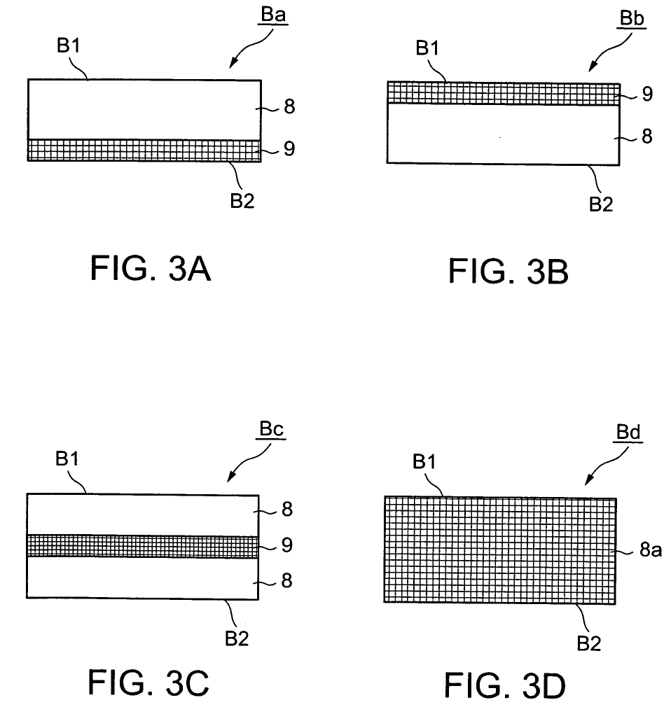

FIGS. 3A to 3D illustrate several modifications to the dummy substrate BB shown in FIG. 1, applicable to the first embodiment of the optical storage medium DD according to the present invention.

The dummy substrate BB may not be transparent if a laser beam is not incident thereon in recording or reproduction. In other words, it may be provided with a light shielding layer 9 or 8a made of a colored or metal film on a substrate as shown in FIGS. 3A to 3D for enhanced storage stability against light exposure.

A preferable transmittancy T for the dummy substrate BB is in the range from 0% to 25% at 350 nm in wavelength λ. A transmittancy T over 25% lowers light fastness. The transmittancy T is defined as a light transmittancy to the region from the incident plane B1 of the dummy substrate BB to the surface (the dummy substrate side) of the reflective layer 5 of the recording substrate AA. In other words, the transmittancy T depends on all substances (layers) included in that region.

FIGS. 3A to 3D show four modifications to the dummy substrate BB, having the light shielding layer 9 or 8a that adjusts the transmittancy T.

A dummy substrate Ba (a first modification) shown in FIG. 3A has a substrate 8 at an incident plane B1 side and a light shielding layer 9 at a surface B2 side to be boned to the recording substrate AA.

A dummy substrate Bb (a second modification) shown in FIG. 3B has a light shielding layer 9 at an incident plane B1 side and a substrate 8 at a surface B2 side to be bonded to the recording substrate AA.

A dummy substrate Bc (a third modification) shown in FIG. 3C has two substrates 8 and a light shielding layer 9 interposed therebetween.

A dummy substrate Bd (a fourth modification) shown in FIG. 3D has a colored substrate 8a acting as a light shielding layer 9.

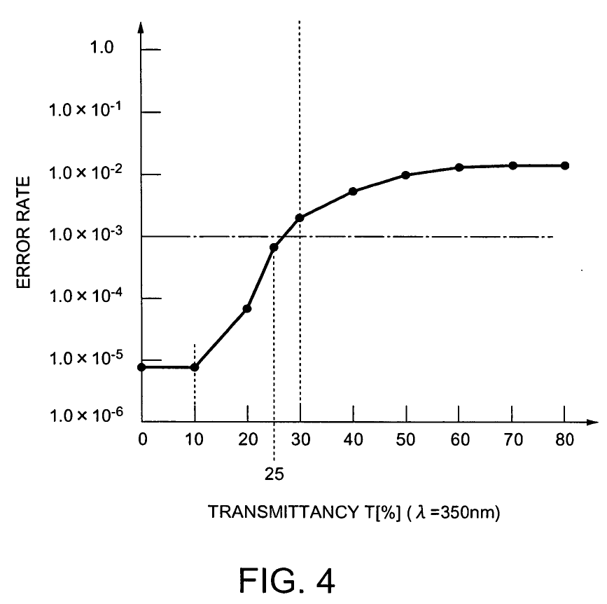

Shown in FIG. 4 is a graph indicating error rate in recording/reproduction on/from the optical storage medium DD after irradiated with incandescent or white light at 30,000 lux for 600 hours to transmittancy T of the dummy substrate BB to light of 350 nm in wavelength λ. The wavelength around 350 nm in the range of ultraviolet rays gives most intense photochemical reaction because the third protective layer 6 of the recording substrate AA is usually made of an ultraviolet-cured organic material.

The graph shows that a transmittancy T of 30% or higher causes higher error rate over 1×10⁻³.

It is known that an error rate over 1×10⁻³ makes error correction difficult.

Thus, an acceptable transmittancy T for the dummy substrate BB is in the range from 0% to 25%, preferably, to 10%. Nevertheless, the transmittancy T may not be adjusted by a light transmittancy of the dummy substrate BB only. This is because, as defined, the transmittancy T indicates how much light passes from the incident plane B1 of the dummy substrate BB to the surface of the reflective layer 5 of the recording substrate AA.

Preferably, the total light transmittancy of the layers existed from the incident plane B1 of the dummy substrate BB to the surface of the reflective layer 5 of the recording substrate AA is set within the range from 0% to 25%, preferably, to 10% (the acceptable range of the transmittancy T).

A suitable material for the substrate 8 of the dummy substrate BB may be a transparent material, for example, glass, polycarbonate, polymethylmethacrylate, polyolefin resin, epoxy resin, or polyimide resin. Most suitable material is polycarbonate resin for low hygroscopicity and easiness to process.

The light shielding layer 9 of the dummy substrate BB can be made of any material that blocks off light incident through the incident plane B1. A preferable material for the light shielding layer 9 is metal, such as an alloy of Al, which is easily thinned to enhance productivity.

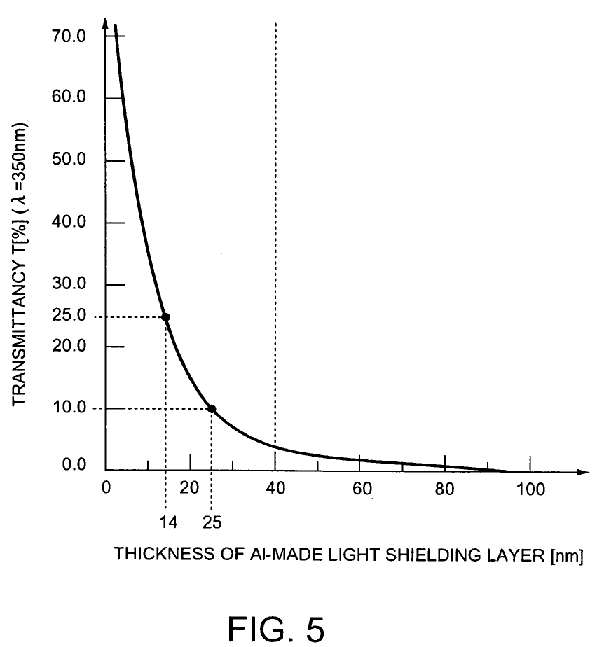

Shown in FIG. 5 is a graph indicating transmittancy T at 350 nm in wavelength λ to thickness of the light shielding layer 9 made of an alloy of Al with a 0.6 mm-thick substrate 8 made of polycarbonate.

The graph indicates the thickness of the light shielding layer 9 less than 40 nm drastically increases the transmittancy T. It is taught that the thickness of the light shielding layer 9 at 14 nm or more offers the transmittancy T of 25% or less, 25 nm or more, 10% or less.

The dummy substrates Ba to Bd shown in FIGS. 3A to 3D exhibit substantially the same tendency as shown in FIG. 5.

The recording substrate AA and the dummy substrate BB may be bonded to each other with a radiation-cured organic compound or a composition thereof cured with radiation of an electron beam, ultraviolet rays, etc., or with an adhesive sheet.

An adhesive or an adhesive sheet exhibiting light transmittancy in the range from 0% to 25% at 350 nm λ in wavelength is preferably used for the adhesive layer CC (FIG. 1) for higher light fastness.

The recording substrate AA and the dummy substrate BB may be bonded to each other with an air-sandwich or -incident structure or a tight-bonding structure.

Another recording substrate AA′ identical to the recording substrate AA, but without the substrate 1 (FIG. 2) can be provided on the substrate AA and bonded to the dummy substrate BB via the adhesive layer CC as a double-layer optical storage medium.

[Method of Production of Optical Storage Medium]

Disclosed below is a method of producing first embodiment of the optical storage medium DD according to the present invention.

Lamination of the first protective layer 2, the recording layer 3, the second protective layer 4, the reflective layer 5, etc., on the substrate 1 is achieved by any known vacuum thin-film forming technique, such as, vacuum deposition with resistive heating or electron bombardment, ion plating, (D.C., A.C. or reactive) sputtering. The most feasible among the techniques is sputtering for easiness of composition and film-thickness control.

A film-forming system feasible in this method is a batch system in which a plural number of substrates 1 are simultaneously subjected to a film forming process in a vacuum chamber or a single-wafer system in which substrates 1 are processed one by one.

The thickness of the first protective layer 2, the recording layer 3, the second protective layer 4, the reflective layer 5, etc., can be adjusted with control of power to be supplied and its duration in sputtering or monitoring conditions of deposited layers with a crystal oscillator.

The first protective layer 2, the recording layer 3, the second protective layer 4, the reflective layer 5, etc., can be formed while each substrate 1 is being stationary, transferred or rotating. Rotation of the substrate (and further with orbital motion) is most feasible for higher uniformity. An optional cooling process minimizes warpage of the substrate 1.

A dielectric layer of ZnS and/or SiO₂ or the third protective layer 6 made of, for example, an ultraviolet-cured resin may be provided on the reflective layer 5 to protect the underneath thin layers against deformation.

A surface A2 (FIG. 2) of the third protective layer 6 (or the protective layer 5 if the layer 6 is not provided) of the recording substrate Aa and the surface B2 of the dummy substrate Ba, Bb, Bc or Bd (FIGS. 3A to 3D) are bonded to each other via the adhesive layer CC.

The recording layer 3 is preferably initialized before recording. This is achieved by radiating a laser beam or light of a xenon flash lamp onto the recording layer 3 so that the layer 3 is heated and thus crystallized. Initialization with a laser beam is a better choice for less noise in reproduction.

Discussed below is evaluation of samples 1 to 3 produced based on the optical storage medium DD as the first embodiment according to the present invention and comparative samples 1 and 2.

The samples 1 to 3 and the comparative samples 1 and 2 were produced as phase-change optical disks.

An optical-disk drive tester (DDU1000) equipped with a 658 nm-wavelength laser diode and an optical lens (NA=0.60) made by Pulstec. Co. was used in recording and reproduction to and from the sample and comparative sample optical disks. The recording characteristics of each optical disk was evaluated on error rate.

The test of storage stability was conducted for the sample and the comparative sample optical disks as follows:

The sample and comparative samples optical disks were preserved for 100 hours, under high temperature and humidity conditions, at 80° C. in temperature and 85% in relative humidity (RH). After that, each disk was irradiated with incandescent or white light at 30,000 lux for 600 hours (radiation conditions) via the incident plane B1 of the dummy substrate BB.

After a storage processing under the high temperature and humidity conditions and the radiation conditions, test data was recorded on non-recorded regions of each of the sample and comparative sample optical disks.

The error rate was then measured for each of the sample and comparative sample optical disks. Any optical disk that exhibited an error rate of 1×10⁻³ or higher was judged as a defective disk or NG (No Good). An error rate of 1×10⁻³ or higher is known as the level at which error correction is difficult.

The transmittancy T was measured for each of the sample and comparative sample optical disks with a 330-spectrophotometer made by Hitachi. Co.

The sample and comparative sample optical disks were produced and evaluated as follows:

[Sample 1]

A recording substrate Aa was produced as having several layers, such as shown in FIG. 2, on a substrate 1 made of a polycarbonate resin with 120 mm in diameter and 0.6 mm in thickness. Formed alternately on the substrate 1 were grooves and lands at 0.74 μm in track pitch, with 25 nm in groove depth and about 40:60 in width ratio of groove to land.

In detail, a bare substrate 1 was set in a vacuum chamber after the chamber was exhausted up to 3×10⁻⁴ Pa.

A 70 nm-thick first protective layer 2 was formed on the substrate 1 with ZnS added with 20-mol % SiO₂ at 2×10⁻¹ Pa in Ar-gas atmosphere.

Formed on the first protective layer 2, in order, were a 16 nm-thick recording layer 3 with a target of an alloy of 4 elements Ge—In—Sb—Te, a 16 nm-thick second protective layer 4 of the same material as the first protective layer 2, a 2 nm-thick GeN-made barrier layer 10, and a 120 nm-thick reflective layer 5 with a target of Ag—Pd—Cu.

The substrate 1 formed with these layers was taken out from the vacuum chamber.

The reflective layer 5 was spin-coated with an acrylic ultraviolet-cured resin (SK5110 made by Sony Chemicals. Co.). The resin was cured with radiation of ultraviolet rays so that a 3 μm-thick third protective layer 6 was formed on the reflective layer 5.

As disclosed, the recording substrate Aa was produced with an incident plane A1 and an adhesive surface A2, such as shown in FIG. 2.

A dummy substrate Ba was produced next, such as shown in FIG. 3A.

In detail, a substrate 8 was made of a polycarbonate resin with 120 mm in diameter and 0.6 mm in thickness, the same as the substrate 1 of the recording substrate Aa.

A light shielding layer 9 of 35 nm in thickness was formed on the substrate 8 by sputtering with a target of Al.

As disclosed, the dummy substrate Ba was produced with an adhesive surface B2 on the light shielding layer 9, such as shown in FIG. 3A.

The dummy substrate Ba exhibited 3% in transmittancy T at 350 nm in wavelength.

The adhesive surface A2 of the recording substrate Aa and the adhesive surface B2 of the dummy substrate Ba were bonded to each other via an adhesive layer CC of an adhesive sheet, thus a sample-1 optical storage medium (phase-change optical disk) DD was produced.

The recording layer 3 of the sample-1 optical disk DD was initialized by an initialization device (POP120 made by Hitachi Computer Peripherals, Co.) with a laser beam having 250 μm in beam width in radial direction and 1.0 μm in beam width in scanning direction, at 4.5 m/s in scanning velocity, 1600 mW in laser power and 220 μm in scanning pitch.

Test data was recorded, at 3.5 m/s in linear velocity (corresponding to “×1” speed in DVD standards), on guide grooves of the recording layer 3 through the incident plane A1 of the substrate 1 of the recording substrate Aa. The guide grooves were projected from the recording layer 3 when viewed from an incident laser beam.

Error-rate measurement indicated that the sample-1 optical disk DD exhibited 2×10⁻⁵ in recording characteristics before preserved for 100 hours, under high temperature and humidity conditions, at 80° C. in temperature and 85% in relative humidity (RH).

Further recording and errror-rate measurements after the storage processing under the high temperature and humidity conditions and radiation conditions (radiation of incandescent or white light at 30,000 lux for 600 hours) indicated as follows:

The sample-1 optical disk DD (SP 1) exhibited 5×10⁻⁵ in recording characteristics, with 3% in transmittancy T of the dummy substrate Ba having the 35 nm-thick light shielding layer 9 (before bonded), as shown in TABLE 1, acceptable (OK) characteristics after the storage processing.

TABLE 1

| | | TRANSMITTANCY T in | |
|---|---|---|---|
| | THICKNESS | DUMMY B | |
| | in LAYER 9 | (λ = 350 nm) | ERROR RATE |
| SP 1 | 35 nm | 3% | 5.0 × 10⁻⁵ (OK) |
| SP 2 | 70 nm | 0% | 2.0 × 10⁻⁵ (OK) |
| SP 3 | 15 nm | 22% | 3.0 × 10⁻⁴ (OK) |
| CSP 1 | 0 nm | 82% | 2.0 × 10⁻³ (NG) |
| CSP 2 | 10 nm | 37% | 1.0 × 10⁻³ (NG) |

[Sample 2]

A sample-2 (SP 2) optical disk DD was produced in the same way as the sample 1 except that the sample 2 had a 70 nm-thick light shielding layer 9.

As shown in TABLE 1, a dummy substrate Ba of the sample 2 exhibited 0% in transmittancy T at 350 nm in wavelength λ (before bonded), with an error rate of 2×10⁻⁵ in recording/reproduction, acceptable (OK) characteristics after the storage processing, like the sample 1.

[Sample 3]

A sample-3 (SP 3) optical disk DD was produced in the same way as the sample 1 except that the sample 3 had a 15 nm-thick light shielding layer 9.

As shown in TABLE 1, a dummy substrate Ba of the sample 3 exhibited 22% in transmittancy T at 350 nm in wavelength λ (before bonded), with an error rate of 3×10⁻⁴ in recording/reproduction, acceptable (OK) characteristics after the storage processing, like the sample 1.

[Comparative Sample 1]

A comparative sample-1 (CSP 1) optical disk DD was produced in the same way as the sample 1 except that a CSP-1 dummy substrate BB had no (0 nm-thick) light shielding layer 9.

As shown in TABLE 1, the CSP-1 dummy substrate BB of the comparative sample 1 exhibited 82% in transmittancy T at 350 nm in wavelength λ (before bonded), with an error rate of 2×10⁻³ in recording/reproduction, extremely unacceptable (NG) characteristics after the storage processing, when compared with the sample 1.

[Comparative Sample 2]

A comparative sample-2 (CSP 2) optical disk DD was produced in the same way as the sample 1 except that a CSP-2 dummy substrate Ba had a 10 nm-thick light shielding layer 9.

As shown in TABLE 1, the CSP-2 dummy substrate Ba of the comparative sample 2 exhibited 37% in transmittancy T at 350 nm in wavelength λ (before bonded), with an error rate of 1×10⁻³ in recording/reproduction, extremely unacceptable (NG) characteristics after the storage processing, when compared with the sample 1.

The test teaches that optical disks without the light shielding layer 9 or with this layer but not thick enough suffer drastically inferior recording characteristics when the reflective layer 5 is exposed to light for long hours.

Analysis of the results by the inventors of the present invention is that the ultraviolet-cured resin of the third protective layer 6 and Ag or an alloy of Ag of the reflective layer 5 were activated due to light exposure, which affected the characteristics of the reflective layer 5 and also heat dissipation, which must have led inferior recording characteristics.

As already discussed, it is known that error-correctable error rate is 1×10⁻³ or lower. It is therefore concluded that an acceptable range of the transmittancy T to the reflective layer 5 is between 0% and 25% against light exposure at 350 nm in wavelength λ.

This acceptable range from 0% to 25% was achieved in the samples 1 to 3 with adjustments to the thickness of the light shielding layer 9 of the dummy substrate Ba against light having a wavelength λ of 350 nm (including a laser beam having this wavelength), as disclosed above.

Instead, such an acceptable range of the transmittancy T can be achieved, for example, by mixing powder of carbon black into the third protective layer 6 (FIG. 2) or the adhesive layer CC (FIG. 1) to exhibit a light-shielding capability.

### Second Embodiment of Optical Storage Medium

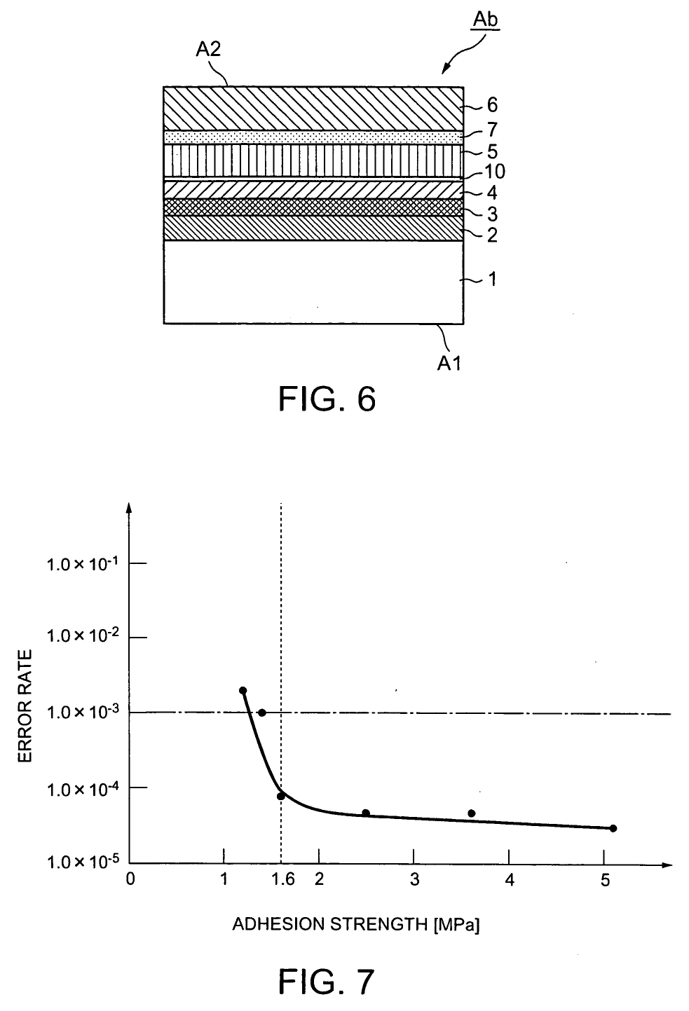

FIG. 6 shows a recording substrate Ab used for a second embodiment of the optical storage medium DD according to the present invention.

The recording substrate Ab has a highly-adhesive inert layer 7 between the reflective layer 5 and the third protective layer 6. This is another technique to enhance a light-shielding capability when the transmittancy T in the range from 0% and 25% against light having a wavelength λ of 350 nm cannot be achieved by the techniques disclosed above for some reasons.

An optical storage medium suffers inferior recording characteristics when it is exposed to light through the incident plane B1 of the dummy substrate BB.

An observation by the inventors of the present indicates that this unacceptable phenomenon occurs only when the reflective layer 5 made of Ag or an alloy of Ag and the third protective layer 6 are directly contact with each other and this reflective layer 5 made of Ag or an alloy of Ag is exposed to light for long hours.

The reflective layer 5 still exhibits a metallic luster even though it is exposed to light for long hours. This makes the inventors of the present invention believe the following consequences:
A chemical reaction between the compositions of the third protective layer 6 and Ag or an alloy of Ag, the metallic material of the reflective layer 5, is accelerated by light exposure, which gives chemical reaction (although not corrosion) to the metallic material of the reflective layer 5.
This photoactivated chemical reaction of the reflective layer 5 varies thermal conductivity of the metallic material of this layer, which causes inferior heat dissipation in recording, thus resulting in inferior recording characteristics.

The chemical reaction of the reflective layer 5 is not corrosion in which a metal loses its metallic nature but change from one particular metal to another metal.

It is thus concluded that the highly-adhesive inert layer 7 serves to enhance a light-shielding capability when provided between the reflective layer 5 and the third protective layer 6.

The recording substrate Ab, shown in FIG. 6, has a first protective layer 2, a recording layer 3, a second protective layer 4, a barrier layer 10, a reflective layer 5, a highly-adhesive inert layer 7, and a third protective layer 6, laminated in order on a substrate 1. Like the first embodiment, the barrier layer 10 is not essential in the second embodiment and may be omitted as discussed above.

The layers of the recording substrate Ab except the highly-adhesive inert layer 7 are identical to those of the recording substrate Aa, in material, thickness, etc.

The material of the highly-adhesive inert layer 7 may be a metal, a metalloid, a nitride, an oxide, a carburet, or a compound of any of these materials. One preferable requirement for the material of the layer 7 is adhesion strength of 1.6 MPa or higher to the reflective layer 5 made of Ag or an alloy of Ag.

FIG. 7 shows a graph indicating error rate in recording/reproduction to adhesion strength between the reflective layer 5 and the highly-adhesive inert layer 7, after samples were preserved for 100 hours at 80° C. in temperature and 85% in relative humidity (RH), and then irradiated with incandescent or white light at 30,000 lux for 600 hours.

FIG. 7 teaches that an adhesion strength lower than 1.6 MPa causes increase in error rate over 1×10⁻³ or higher that is known as the level at which error correction is difficult.

Thus, an acceptable adhesion strength is 1.6 MPa or higher between the reflective layer 5 and the highly-adhesive inert layer 7.

It is believed that an adhesion strength lower than 1.6 MPa causes detachment between the reflective layer 5 and the highly-adhesive inert layer 7 under the high temperature and humidity conditions (80° C., 85% RH). Such detachment makes an optical disk whitish, thus looking bad and also decreases a light-shielding capability of the layer 7, resulting in inferior recording characteristics due to light exposure.

There is no particular upper limit for the adhesion strength between the reflective layer 5 and the highly-adhesive inert layer 7. In other words, any level of adhesion strength, 1.6 MPa or higher, is acceptable.

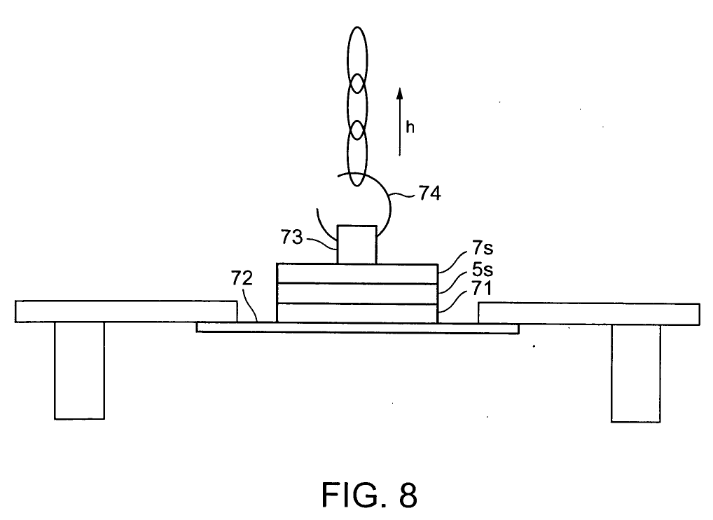

A tensile test, such as illustrated in FIG. 8, was conducted to measure the adhesion strength between the reflective layer 5 and the highly-adhesive inert layer 7.

Each test sample had an about 200 nm-thick thin film 5s made of Ag or an alloy of Ag used for the reflective layer 5 and a 200 nm-thick thin film 7s made of a material used for the highly-adhesive inert layer 7, laminated in order on a glass substrate 71.

Each test sample was fixed on a SUS plate 72 with an epoxy adhesive. A square rod was fixed on the test sample with an epoxy adhesive.

Each test sample was hung by a C-hook 74 so that the sample could be pulled in a direction “h” orthogonal to the SUS plate 72.

The tensile test was conducted while each test sample was remaining stationary.

Measured in this test was force that caused fracture between the thin film 5s (the reflective layer 5) and the thin film 7s (the highly-adhesive inert layer 7).

Adhesion strength was then given by dividing the measured force by the area of each test sample.

Discussed next is evaluation of adhesion strength and error rate for samples 4 to 7 of the second embodiment provided with the highly-adhesive inert layer 7 and comparative samples 3 and 4.

The recording substrate Ab (the second embodiment), shown in FIG. 6, is produced by the same method as for the recording substrate Aa (first embodiment), shown in FIG. 2, for the protective layer 2, the recording layer 3, the second protective layer 4, the reflective layer 5, and the third protective layer 6 on the substrate 1. The highly-adhesive inert layer 7 is also produced in the same way as these layers.

A dummy substrate Bb in the second embodiment has a substrate 8 only, with no light shielding layer 9, different from those shown in FIGS. 3A to 3D.

The recording substrate Ab and the dummy substrate Bb are bonded to each other via an adhesive seal as the adhesive layer CC.

As discussed below, evaluation of recording characteristics, test of storage stability and error-rate measurements were conducted for the samples 4 to 7 and the comparative samples 3 and 4 in the same way as the samples 1 to 3 and the comparative samples 1 and 2.

[Sample 4]

A sample-4 (SP 4) optical disk had the same structure as the sample 1 except that, in the former, the dummy substrate Bb had no light shielding layer 9, but the recording substrate Ab had a 5 nm-thick GeN-made highly-adhesive inert layer 7 between the AgPdCu-made reflective layer 5 and the third protective layer 6.

As shown in TABLE 2 below, the sample 4 (SP 4) exhibited 5.1 MPa in adhesion strength between AgPdCu of the reflective layer 5 and GeN of the highly-adhesive inert layer 7 in the tensile test.

Moreover, the sample 4 exhibited 5×10⁻⁵ in error rate in recording/reproduction, acceptable (OK) recording characteristics, after preserved and measured in the same conditions as the sample 1.

TABLE 2

| | HIGHLY-ADHESIVE INERT LAYER | | |
|---|---|---|---|
| | MATERIAL | ADHESION STRENGTH | ERROR RATE |
| SP 4 | GeN | 5.1 MPa | 5.0 × 10⁻⁵ (OK) |
| SP 5 | A1₂O₃ | 3.6 MPa | 6.0 × 10⁻⁵ (OK) |
| SP 6 | Ge | 1.6 MPa | 9.0 × 10⁻⁵ (OK) |
| SP 7 | NiCr | 2.5 MPa | 6.0 × 10⁻⁵ (OK) |
| CSP 3 | Al | 1.2 MPa | 3.0 × 10⁻³ (NG) |
| CSP 4 | Cu | 1.4 MPa | 1.0 × 10⁻³ (NG) |

[Sample 5]

A sample-5 (SP 5) optical disk had the same structure as the sample 4 except that the former had a 5 nm-thick Al₂O₃-made highly-adhesive inert layer 7 between the AgPdCu-made reflective layer 5 and the third protective layer 6.

As shown in TABLE 2, the sample 5 (SP 5) exhibited 3.6 MPa in adhesion strength between AgPdCu of the reflective layer 5 and Al₂O₃ of the highly-adhesive inert layer 7 in the tensile test.

Moreover, the sample 5 exhibited 6×10⁻⁵ in error rate in recording/reproduction, acceptable (OK) recording characteristics, after preserved and measured in the same conditions as the sample 1.

[Sample 6]

A sample-6 (SP 6) optical disk had the same structure as the sample 4 except that the former had a 5 nm-thick Ge-made highly-adhesive inert layer 7 between the AgPdCu-made reflective layer 5 and the third protective layer 6.

As shown in TABLE 2, the sample 6 (SP 6) exhibited 1.6 MPa in adhesion strength between AgPdCu of the reflective layer 5 and Ge of the highly-adhesive inert layer 7 in the tensile test.

Moreover, the sample 6 exhibited 9×10⁻⁵ in error rate in recording/reproduction, acceptable (OK) recording characteristics, after preserved and measured in the same conditions as the sample 1.

[Sample 7]

A sample-7 (SP 7) optical disk had the same structure as the sample 4 except that the former had a 5 nm-thick NiCr-made highly-adhesive inert layer 7 between the AgPdCu-made reflective layer 5 and the third protective layer 6.

As shown in TABLE 2, the sample 7 (SP 7) exhibited 2.5 MPa in adhesion strength between AgPdCu of the reflective layer 5 and NiCr of the highly-adhesive inert layer 7 in the tensile test.

Moreover, the sample 7 exhibited 6×10⁻⁵ in error rate in recording/reproduction, acceptable (OK) recording characteristics, after preserved and measured in the same conditions as the sample 1.

[Comparative Sample 3]

A comparative sample-3 (CSP 3) optical disk had the same structure as the sample 4 except that the former had a 5 nm-thick Al-made highly-adhesive inert layer 7 between the AgPdCu-made reflective layer 5 and the third protective layer 6.

As shown in TABLE 2, the comparative sample 3 (CSP 3) exhibited 1.2 MPa in adhesion strength between AgPdCu of the reflective layer 5 and Al of the highly-adhesive inert layer 7 in the tensile test.

Moreover, the comparative sample 3 exhibited 3×10⁻³ in error rate in recording/reproduction, extremely unacceptable (NG) recording characteristics when compared with the sample 1, after preserved and measured in the same conditions as the sample 1.

[Comparative Sample 4]

A comparative sample-4 (CSP 4) optical disk had the same structure as the sample 4 except that the former had a 5 nm-thick Cu-made highly-adhesive inert layer 7 between the AgPdCu-made reflective layer 5 and the third protective layer 6.

As shown in TABLE 2, the comparative sample 4 (CSP 4) exhibited 1.4 MPa in adhesion strength between AgPdCu of the reflective layer 5 and Cu of the highly-adhesive inert layer 7 in the tensile test.

Moreover, the comparative sample 4 exhibited 1×10⁻³ in error rate in recording/reproduction, extremely unacceptable (NG) recording characteristics when compared with the sample 1, after preserved and measured in the same conditions as the sample 1.

As evaluated above, the Al— and Cu-made highly-adhesive inert layers 7 caused inferior adhesion strength to the reflective layer 5, which resulted in detachment between the layers 5 and 7 under the high temperature and humidity conditions (80° C., 85% RH), leading inferior characteristics to these intermediate layers.

Such unacceptable phenomenon is believed to activate the ultraviolet-cured resin of the third protective layer 6 and Ag or an alloy of Ag of the reflective layer 5, under the radiation conditions (30,000 lux, 600 hours) after the high temperature and humidity conditions, thus causing inferior recording characteristics.

As discussed above, in the second embodiment, in which the dummy substrate Bb has no light-shielding layer 9, the recording substrate Ab requires the highly-adhesive inert layer 7 between the reflective layer 5 and the third protective layer 6 for restricting activation of chemical reaction between Ag or an alloy of Ag of the layer 5 and the ultraviolet-cured resin of the layer 6.

An acceptable material for the highly-adhesive inert layer 7 exhibits adhesion strength of 1.6 MPa or higher to the reflective layer 5. The adhesion strength below 1.6 MPa causes detachment under the high temperature and humidity conditions (80° C., 85% RH), resulting in inferior recording characteristics before light exposure.

The recording substrate Ab having the highly-adhesive inert layer 7 (FIG. 6) and any of the dummy substrates Ba to Bd (FIGS. 3A to 3D) can be bonded to each other via the adhesive layer CC, as modifications to the optical storage medium DD according to the present invention.

The modifications achieve adjustments to the transmittancy T to the reflective layer 5 and also restriction of chemical reaction of this layer, like the first and second embodiments, thus maintaining high recording/reproduction characteristics under the high temperature and humidity conditions (80° C., 85% RH) and the radiation conditions (30,000 lux, 600 hours).

As disclosed above, the present invention achieves and maintains high recording/reproduction characteristics under sever conditions, such as, high temperature, high humidity and light exposure (a fluorescent light, sunlight, etc.) which could otherwise cause deterioration in materials of an optical storage medium.

Any of the embodiments and modifications is applicable depending on productivity.

1. An optical disk comprising:
a recording substrate having a first light incident plane and a first bonding surface on both sides thereof, data being to be recorded in the recording substrate via the first light incident plane; and
a support base constituted by at least one component and having a second light incident plane and a second bonding surface on both sides thereof, the recording substrate and the support base being bonded to each other via the first and second bonding surfaces,
wherein the recording substrate is constituted by components that are at least a first substrate, a recording layer and a reflective layer, the first substrate having a first substrate surface and a second substrate surface on both sides thereof, the first incident plane being provided on the first substrate surface, the recording layer being provided on the second substrate surface, the reflective layer made of at least silver and having a first layer surface and a second layer surface on both sides thereof, the first layer surface being provided on the recording layer as the first layer surface faces with the second substrate surface via the recording layer, and
at least one component that exists between the second light incident plane of the support base and the second layer surface of the reflective layer exhibits a transmittancy in the range from 0% to 25% when the optical disk is exposed to light having a wavelength of 350 nm through the second light incident plane.

2. The optical disk according to claim 1, wherein the support base is constituted by two components that are a dummy substrate and a bonding layer, the recording substrate and the support base being bonded to each other via the bonding layer.

3. The optical disk according to claim 2, wherein the dummy substrate is constituted by a second substrate and a light shielding layer that exhibits a transmittancy in the range from 0% to 25%, when the dummy substrate is exposed to light having the wavelength of 350 nm before the dummy substrate is bonded to the recording substrate, which gives the transmittancy of the component that exists between the second light incident plane of the support base and the second layer surface of the reflective layer.

4. The optical disk according to claim 2, wherein the dummy substrate exhibits a transmittancy in the range from 0% to 25%, when the dummy substrate is exposed to light having the wavelength of 350 nm before the dummy substrate is bonded to the recording substrate, which gives the transmittancy of the component that exists between the second light incident plane of the support base and the second layer surface of the reflective layer.

5. The optical disk according to claim 2, wherein a further component of the recording substrate is a protective layer provided on the second layer surface of the reflective layer, the protective layer having a light-shielding capability that gives the transmittancy of the component that exists between the second light incident plane of the support base and the second layer surface of the reflective layer.

6. The optical disk according to claim 2, wherein the bonding layer has a light-shielding capability that gives the transmittancy of the component that exists between the second light incident plane of the support base and the second layer surface of the reflective layer.

7. An optical disk comprising:
a recording substrate having a first light incident plane and a first bonding surface on both sides thereof, data being to be recorded in the recording substrate via the first light incident plane; and
a support base having a second bonding surface, the recording substrate and the support base being bonded to each other via the first and second bonding surfaces,
wherein the recording substrate is constituted by at least a substrate, a recording layer, a reflective layer made of at least silver, an inert layer, and an organic protective layer, the substrate having a first substrate surface and a second substrate surface on both sides thereof, the first incident plane being provided on the first substrate surface, the recording layer, the reflective layer, the inert layer and the organic protective layer being provided on the second substrate surface in order, the inert layer restricting a chemical reaction between the reflective layer and the organic protective layer.

8. The optical disk according to claim 7, wherein the support base has a dummy substrate and a bonding layer, the recording substrate and the support base being bonded to each other via the bonding layer.

9. The optical disk according to claim 7, wherein adhesion strength between the reflective layer and the inert layer is 1.6 MPa or higher.
